(19) United States
(12) Patent Application Publication
(10) Pub. No.: US 2017/0261421 A1
(43) Pub. Date: Sep. 14, 2017

(54) METHOD FOR ESTIMATING THE RISK OF CORROSION

(71) Applicant: Technische Universität Wien, Wien (AT)

(72) Inventor: Paul Linhardt, Wien (AT)

(21) Appl. No.: 15/505,029

(22) PCT Filed: Aug. 21, 2015
(86) PCT No.: PCT/EP2015/069229

§ 371 Date: Feb. 17, 2017

(30) Foreign Application Priority Data
Aug. 21, 2014 (AT) A651/2014

(51) Int. Cl. G01N 17/04; G01N 27/04; G01N 17/00

(52) U.S. Cl. CPC G01N 17/043; G01N 17/008; G01N 17/006; G01N 27/04

(57) ABSTRACT

A method for determining the corrosion risk caused by biofilm formation for installations in natural bodies of water includes a) providing a device for measuring electrode potentials, comprising at least one metal sample and at least one reference electrode at a location close to the installation within the natural body of water b) continuously or intermittently measuring potential differences between said at least one metal sample and said at least one reference electrode over a sufficiently long period of time to allow for identifying any changes of potential of the sample resulting from ennoblement caused by biofilm formation, c) comparing the measured potential difference to one or more reference values for the respective metal of the metal sample, and d) estimating if and when the potential difference resulting from biofilm formation attains or may attain a critical value which would result in the corrosion of the respective metal at the respective location of the natural body of water.

### CROSS-REFERENCE TO RELATED APPLICATIONS

This application is a National Stage application of International Application No. PCT/EP2015/069229, filed Aug. 21, 2015, which claims benefit to Austrian Application No. A651/2014, filed Aug. 21, 2014, which are incorporated by reference herein in their entireties.

### BACKGROUND

Field

The present invention relates to a method for assessing the risk of corrosion caused by biofilm formation for installations located or to be constructed in natural bodies of water.

Description of the Related Art

Ennoblement is a special electrochemical effect caused by biofilms, which occasionally occurs and may significantly intensify corrosion of metallic materials. Consequently, microbially influenced corrosion (MIC) may occur. In specific terms, ennoblement is a change towards an anodic potential caused by a strong oxidant produced by microbes. Please also refer to a publication by the present inventor from the 2013 European Corrosion Congress (P. Linhardt, “MIC in Hydroelectric Power Plants and Approaches for Risk Assessment”, EUROCORR 2013, Paper 1279, S. 1-5) which refers to ennoblement caused by manganese dioxide which is biomineralized by manganese-oxidizing microorganisms. In the past decades, there were, among other things, cases in which this phenomenon resulted in the damage of hydropower plants.

Damage analysis currently only indirectly detects ennoblement in the course of chemical and biological analyses of deposits and measurements in situ, which are often only possible to a limited extent. It is thus not possible to draw any conclusions as to the probability of the occurrence of ennoblement based on a routine analysis of the chemical composition of the water. Even more comprehensive chemical analytical data do not provide any useful information, as the substances relevant for ennoblement are formed by microorganisms and accumulated directly on the material surface, so that these substances cannot be detected in the body of water, making it impossible to predict their potential formation with a reasonable degree of certainty.

In addition, it is highly probable that not all (bio-) chemical mechanisms resulting in ennoblement are known today, so that not even a chemical analysis of a biofilm itself allows to make reliable statements.

Microbiological examinations also seem hardly useful. On the one hand, the currently known organisms causing ennoblement are ubiquitous, i.e. they are, at least potentially, present everywhere, but only cause ennoblement under certain circumstances which have not been fully understood yet. On the other hand, we have to assume that we currently know and have identified as relevant only a tiny fraction of such organisms.

In this context, U.S. Pat. No. 5,356,521 A discloses a method for monitoring the formation and activity of biofilms, for example in pipes and other water-bearing and -containing vessels; said method consists in immersing two electrodes consisting of the same material into the body of water and measuring the current flowing between these two electrodes, optionally while applying direct voltage. A corresponding measuring probe to be introduced into, for example, a water pipe is claimed in an earlier, largely identical patent application of the same inventor, U.S. Pat. No. 5,246,560, and is illustrated in FIGS. 1 of both documents and commercially available under the trade name BioGeorge™.

The disadvantage of this approach is that, although it is generally possible to detect the formation of biofilms, the risk of occurrence of ennoblement cannot be specifically assessed, as it measures only the current flowing between two identical electrodes, but no corrosion-relevant parameters for certain metals, thus not allowing for any conclusions as to the potential occurrence of ennoblement. The disclosed device is further intended for biofilm monitoring and thus to be permanently installed in existing installations, e.g. water pipes, which means that it cannot be used in natural bodies of water in its presented form.

For this reason, there is a need for a reliable detection procedure which can be carried out making reasonable efforts. Additionally, a reliable prediction concerning the occurrence of ennoblement would be extremely useful before the construction of new or expensive overhaul of existing hydropower plants and thus also constituted one of the aims of the invention.

### SUMMARY

The present invention achieves this aim by providing in a first aspect a method for assessing the risk of corrosion caused by biofilm formation for installations located or to be constructed in natural bodies of water, said method comprising:
a) providing a device for measuring electrode potentials, comprising at least one metal sample, preferably a plurality of metal samples, and at least one reference electrode at a location close to the installation within the natural body of water;
b) continuously or intermittently measuring potential differences between said at least one metal sample and said at least one reference electrode over a sufficiently long period of time to allow for identifying any changes of potential of the sample, which result from ennoblement caused by biofilm formation;
c) comparing the measured potential difference to one or more reference values for the respective metal of the metal sample; and
d) estimating if and when the potential difference resulting from biofilm formation attains or may attain a critical value which would result in the corrosion of the respective metal at the respective location of the natural body of water.

The present invention thus allows for an assessment of the risk of ennoblement in a natural body of water directly at the location of an installation such as a hydropower plant by allowing observations how the free corrosion potential of the metal sample(s) is changing in the course of time. When using several samples of different metals, not only specific values for more than one metal may be obtained, but, in addition to identifying changes of the corrosion potential, these metals may also be directly compared to one another. This means that, in step c), both the free corrosion potentials of the respective metal under the respective conditions of use without biofilms and the potential values of other metals, preferably of those metals which are also included in samples in the device and objects of measurements taking place at the same time, may be used as reference values for each metal. These reference values can, for example, be found in tables listing practical corrosion potentials.

Thus, the present invention does not only allow for assessing if and when biofilm formation occurs, as is possible according to prior art, but also for definite statements concerning the corrosive type of biofilm, i.e. whether there is a risk of ennoblement or MIC or not—and if so, after which period of time.

For as precise an assessment of this risk in step d), step c) should use empirical values for the respective metals under corrosive conditions as additional reference values. Observing a change of these values in the course of time, allows for a reliable prognosis whether an installation may be subjected to a higher corrosion exposure and thus a higher risk of damage at a certain location within a body of water. In addition to the generally available table of practical corrosion potentials, these empirical values may, for example, also include measurement values for the same metal previously obtained in other bodies of water, preferably using the method of the invention.

In preferred embodiments of the invention, the location is situated in close vicinity to the installation within the natural body of water, i.e. exactly where the metal parts at risk of corrosion are located, making the prognosis more reliable.

In preferred embodiments, the measurements of potential differences are carried out over a period of at least one week, preferably of at least two weeks, which is long enough for any biofilms to form on the sample surface, as it is well-known that ennoblement only occurs after 7 to 10 days. Even more preferably, measurements are carried out over a period of at least four weeks to allow for even more reliable statements. In preferred embodiments, the device is used to additionally measure further environment parameters selected from temperature, light incidence, electrical conductivity and water flow velocity as well as pH and certain ion concentrations in the water, to improve the measurement values' comparability with the reference values and to be able to more reliably extrapolate the behavior of the material sample metals beyond the measurement period.

It is particularly preferred that the device is also used to additionally measure galvanic currents, which, in combination with potential data, allows for an improved quantitative assessment of the corrosive effect of combinations of materials in the installation. This is particularly important in this connection, as the type of corrosive chemical interactions between different materials may be modified by biofilms.

Measurement values obtained when implementing the method of the invention are preferably stored in the device or wirelessly transmitted to a computer or both; to this end, the device preferably comprises a chip memory, e.g. an SSD (“solid state disc”) as a hard disc, and a sender/receiver unit. The device may, of course, also be connected to an external computer via a cable, which is however not preferred for reasons of vulnerability to failures and possibility of positioning the device within a natural body of water.

In a second aspect, the invention also provides a respective device for detecting bio-films with ennoblement effect on metal surface in natural bodies of water by measuring potential differences, said device comprising:
a housing, the interior of which is divided by a separating wall into a watertight compartment and a compartment through which water flows;
one or more mounts which are arranged in the compartment through which the water flows and connected to the housing;
one or more material samples and reference electrodes, attached to each of the one or more mounts;
at least one power supply arranged in the watertight compartment;
electronics arranged in the watertight compartment for measuring potential differences between the material samples and the reference electrodes and for storing and/or transmitting data.

Such a device allows for implementing the method according to the first aspect of the present invention in a particularly advantageous way: the measurement electronics and power supply are protected against water, while the samples are in continuous contact with the body of water whose characteristics potentially responsible for forming biofilms and causing ennoblement are to be examined.

This state is preferably achieved by providing the housing with an external wall which is watertight in the area of the watertight compartment and water-permeable in the area of the compartment through which the water flows. For this reason, it is sufficient to provide a watertight separating wall between the two compartments, while the housing's external water tightness can be ensured by means of the external wall. This means that a frame comprising the two compartments may be covered by different types of walls, i.e. the external wall in the area of the compartment through which the water flows consists of a water-permeable material, while it consists of a watertight material in the area of the watertight compartment.

Alternatively—and particularly preferably according to the present invention—the external wall entirely consists of a watertight material which is provided with openings such as slits or perforations or the like in the area of the compartment through which the water flows to allow for the water to enter. This reduces the production costs of the device.

In a preferred embodiment, water is efficiently prevented from entering the watertight compartment by creating excess pressure of 0.5 to 1 bar, for example, in the watertight compartment, preferably using air from a compressed air cartridge arranged within the device, in particular directly within the watertight compartment. On the one hand, this allows for a leak test to be carried out by an immersion and a visual inspection of the device; on the other hand, it allows for an at least partial compensation of the water pressure acting from the outside on the device (depending on the depth of immersion, of course), reducing the mechanical load, which in turn allows for lighter-weight construction of the device of the invention.

The housing preferably comprises a cover plate, i.e. a boundary plate at the front or back end of the device (in flow direction), said plate being provided with openings which, depending on the plate's positioning in an optionally running water, are intended to either let water enter or to let water which has entered the device upstream escape (with as little resistance as possible). The shape of the cover plate and the number and size of its openings allow for a control of the entire device's flow resistance, no matter at which end of the device the cover plate is in operation.

In some preferred embodiments, the housing is preferably roughly streamline-shaped to allow for a stabilization of its position in relation to the stream when it is intended to be used in running waters. If the cover plate is arranged at the front end in such cases, it is preferably concave, i.e. curved against the current, to reduce the flow resistance of the device. If the cover plate is, however, situated at the back end of the device in operation, the number and size of the openings play a more significant role than the shape of the plate itself. To reduce the device's flow resistance, the openings in the cover plate in these embodiments are preferably larger and/or more numerous (per surface unit) than those in the lateral wall.

It is, however, also possible that an essentially planar cover plate is preferred at the front end of the device, to deliberately offer a higher resistance to the current, for example in almost standing or relatively slowly running waters. The device is preferably kept in its position using an upstream rope or cable. In such cases, the amount of water entering the device is mainly controlled by means of the openings in the cover plate.

In particularly preferred embodiments of the invention, a stainless steel wall, e.g. of a cylinder, or a watertight foil is used as external wall of the device, e.g. a foil of watertight plastic which is sufficiently tough, impact resistant and thick to be able to resist pressure, piercing, and impacts. Non-limiting examples optionally include fiber-reinforced polyamide, ABS, and PVC, having, for example, a wall thickness of 2 to 5 mm.

The mounts are preferably perforated rails to which metal samples can easily be attached, for example using screws. The perforated rails may at the same time form the housing, i.e. be directly covered by the external wall, such as plastic foil, or may be arranged in an adequately formed container, e.g. a stainless steel cylinder.

The electronics are preferably connected to the material samples and the reference electrodes via cables which run through an otherwise sealed opening in the separating wall from the watertight compartment into the compartment through which the water flows.

The electronics preferably comprise at least one voltmeter (more preferably several voltmeters as a precaution in case of failures) and preferably additionally at least one current meter, as has already been mentioned referring to the method of the invention. In particularly preferred embodiments, the electronics comprise at least one potentiostat which may fulfill several functions at the same time.

Additionally, facilities for measuring one or more environment parameters selected from temperature, light incidence, electrical conductivity and flow velocity of the water, pH and concentrations of certain ions are also preferably provided to allow for a more precise definition of the measurement conditions and thus more precise statements as to the proneness of the natural body of water to biofilm formation and ennoblement.

The electronics preferably do not comprise any or not only a storage unit, e.g. an SSD as chip memory, but (also) a sender/receiver for transmitting data during the measurement period, which, as mentioned above, preferably last for several weeks.

In alternative embodiments, the housing comprises two separable parts which comprise the watertight compartment and the compartment through which the water flows respectively and are preferably connected by screws. This allows for an easy replacement of electronics during the measurement period, leaving the samples arranged in the compartment through which the water flows unchanged, so that measurement results are not distorted, which would require the measurement to be repeated.

It is particularly preferred that the device further comprises an anchoring element for anchoring it to the bottom of the body of water and/or a ballast element counteracting buoyancy in the natural body of water to keep the device in its position, particularly when used under water, as is preferred. The device further comprises a floating body serving as a buoy on the water surface to mark the device's position under water.

As such a device may in principle also be used for other purposes than examining biofilm formation and ennoblement, the third aspect of the present invention comprises the use of the device according to the second aspect in the method of the invention.

### BRIEF DESCRIPTION OF THE DRAWINGS

Referring to the appended drawings illustrating non-limiting embodiments of the invention, the invention will be examplarily described below.

FIGS. 1a to 1c show a device according to the second aspect of the invention for carrying out a method of the invention, and

FIG. 2 shows a preferred embodiment of the method of the invention, specifically the design and positioning of the device for its implementation.

### DETAILED DESCRIPTION

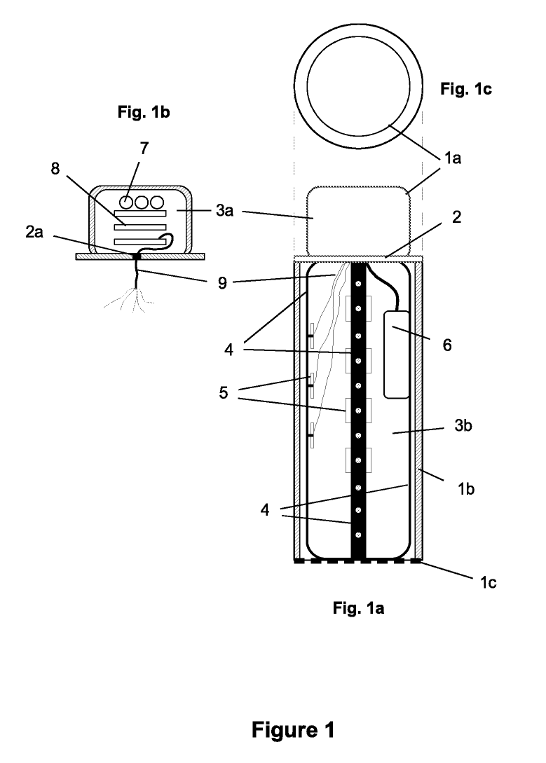

FIG. 1 shows a preferred embodiment of the device according to the second aspect of the invention to examine biofilm formation on metal surfaces in natural bodies of water by measuring potential differences.

FIG. 1a shows a housing (numeral 1) consisting of the parts 1a to 1c, whose interior 3 is divided by a separating wall 2 into a watertight compartment 3a and a compartment 3b through which the water flows. The housing is preferably entirely manufactured of a watertight material, such as a watertight plastic foil (e.g. of PVC) or a stainless steel cylinder, part 1b being provided with slits, holes, or perforations to enable water to enter the interior of compartment 3b.

The cover plate 1c of the housing, which in this case is essentially planar and serves as a bottom plate, is also provided with openings to let water pass, i.e. depending on the device's orientation, let it enter and escape from the interior of the invention during operation.

Mounts 4 arranged in the compartment 3b through which the water flows and firmly connected to the separating wall 2 and the cover plate, e.g. by screws, rivets, and/or adhesive, each of them being intended to receive or fixing one or more material samples 5 and reference electrodes 6. In the embodiment shown in FIG. 1, several samples 5, each preferably comprising another metal to be examined, or two or three samples 5 of the same metal (to allow for averaging), are connected, e.g. by screws or clamps, to each of the mounts 4, which in this case are perforated rails, as is preferred according to the invention.

Additionally, one of the mounts 4 holds a reference electrode 6, which is not subject to specific limitations, but in view on the conditions of use in a natural body of water preferably is a silver/silver chloride electrode, as mercury/mercury salt (e.g. -chloride, -sulfate or -oxide) electrodes are not preferred due to potential mercury contamination resulting from a potential damage or loss of the device.

As mentioned above the mounts 4 may also hold further detectors or measurement probes, e.g. for measuring temperature, light incidence, electrical conductivity and flow velocity of the water, pH and the concentrations of certain ions.

As can be seen in FIG. 1b, the watertight compartment 3a is provided with a power supply 7, which preferably consists of several batteries or rechargeable batteries, which for reasons of environmental friendliness in cases of failure should be free of problematic heavy metals, such as mercury, cadmium, and lead, and electronics 8 for measuring potential differences between the material samples 5 and the reference electrode 6 and for storing and/or transmitting data are provided in the watertight compartment 3a, as indicated by three blocks 8 in FIG. 1.

The electronics are connected to the material samples 5, the reference electrodes 6 and any further measurement facilities via cables 9 which run through an opening in the separating wall 2 and are sealed with respect to this opening to prevent water from entering the compartment 3a.

FIG. 1c shows a plan view of the above device of the invention standing on the cover plate 1c.

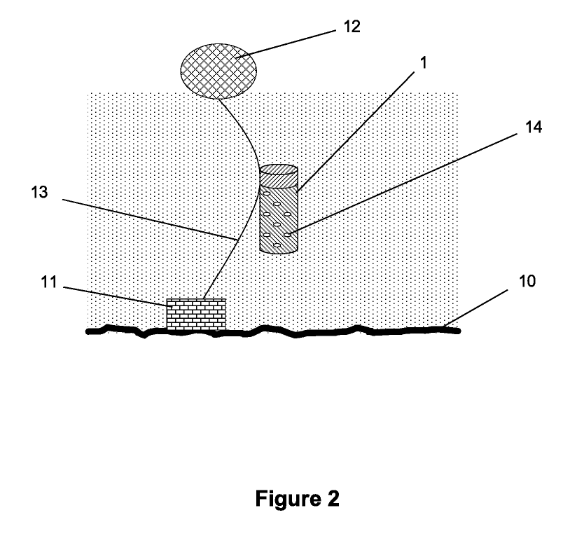

FIG. 2 shows a preferred embodiment of the method of the invention and the design and positioning of the device of the invention for implementing said method. The device, referred to by numeral 1 for the housing as pars pro toto, is connected to an anchoring element 11 via a rope or a cable 13, said anchoring element 11 keeping the device on the bottom 10 of the natural body of water. The anchoring element 11 may either be an actual anchor or simply a sufficiently heavy weight, e.g. a concrete block.

The device 1 is also connected with a floating body 12, e.g. a buoy, via the cable 13, said buoy indicating the device's position under water; numeral 14 refers to a plurality of holes in the housing wall, which let the water enter the compartment through which the water flows.

What is claimed is:

1. A method for assessing the risk of corrosion caused by biofilm formation for installations located or to be constructed in natural bodies of water, said method comprising:
a) providing a device for measuring electrode potentials, comprising at least one metal sample and at least one reference electrode at a location close to the installation within the natural body of water;
b) continuously or intermittently measuring potential differences between said at least one metal sample and said at least one reference electrode over a sufficiently long period of time to allow for identifying any changes of potential of the sample, which result from ennoblement caused by biofilm formation;
c) comparing the measured potential difference to one or more reference values for the respective metal of the metal sample; and
d) estimating if and when the potential difference resulting from biofilm formation attains or may attain a critical value which would result in the corrosion of the respective metal at the respective location of the natural body of water.

2. The method according to claim 1, wherein said location is situated in close proximity to the installation within the natural body of water.

3. The method according to claim 1, wherein the measurements of the potential differences are carried out over a period of at least one week, preferably of at least two weeks.

4. The method according to claim 1, wherein one or more additional environment parameters selected from temperature, light incidence, electrical conductivity and flow velocity of the water, pH, and the concentration of certain ions are measured using said device.

5. The method according to claim 1, wherein additionally galvanic currents are measured using said device.

6. The method according to claim 1, wherein the measurement values are stored in the device and/or wirelessly transmitted to a computer.

7. The method according to claim 1, wherein said installation is a hydropower plant.

8. A device for detecting biofilms with ennoblement effect on metal surfaces in natural bodies of water by measuring potential differences, said device comprising:
a housing, the interior of which is divided by a separating wall into a watertight compartment and a compartment through which the water flows;
one or more mounts arranged in said compartment through which the water flows and connected to the housing;
one or more material samples and reference electrodes attached to each of said one or more mounts;
at least one power supply arranged in said watertight compartment; and
electronics arranged in said watertight compartment for measuring potential differences between said material samples and said reference electrodes and for storing and/or transmitting data.

9. The device according to claim 8, wherein said housing comprises an external wall which is watertight in the area of said watertight compartment and water-permeable in the area of said compartment through which the water flows.

10. The device according to claim 9, wherein said external wall consists of a water-permeable material and/or is provided with openings in the area of said compartment through which the water flows.

11. The device according to claim 8, wherein said housing is roughly streamline-shaped.

12. The device according to claim 8, wherein said housing comprises a cover plate which is provided with openings.

13. The device according to claim 8, wherein said mounts are perforated rails.

14. The device according to claim 8, wherein said electronics are connected to said material samples and said reference electrodes via cables running through an otherwise sealed opening in said separating wall from said watertight compartment into said compartment through which the water flows.

15. The device according to claim 8, wherein said electronics comprise at least one voltmeter.

16. The device according to claim 8, wherein said electronics additionally comprise at least one current meter.

17. The device according to claim 15, further comprising at least one potentiostat.

18. The device according to claim 8, wherein additional facilities for measuring one or more environment parameters selected from temperature, light incidence, electrical conductivity and flow velocity of the water, pH, and the concentration of certain ions are provided.

19. The device according to claim 8, wherein said electronics comprise a sender/receiver for data transmission.

20. The device according to claim 19, wherein said housing comprises two separable parts, comprising said watertight compartment and said compartment through which the water flows, respectively.

21. The device according to claim 8, wherein said two parts of said housing are connected by screws.

22. The device according to claim 8, further comprising an anchoring element for anchoring it to the bottom of the body of water.

23. The device according to claim 8, further comprising a ballast element counteracting buoyancy in the natural body of water.

24. The device according to claim 22, further comprising a floating body serving as a buoy on the water surface.

25. A device for detecting biofilms with ennoblement effect on metal surfaces in natural bodies of water by measuring potential differences, said device comprising:
a housing, the interior of which is divided by a separating wall into a watertight compartment and a compartment through which the water flows;
one or more mounts arranged in said compartment through which the water flows and connected to the housing;
one or more material samples and reference electrodes attached to each of said one or more mounts;
at least one power supply arranged in said watertight compartment; and
electronics arranged in said watertight compartment for measuring potential differences between said material samples and said reference electrodes and for storing and/or transmitting data, the device being used to perform a method for assessing the risk of corrosion caused by biofilm formation for installations located or to be constructed in natural bodies of water, said method comprising:
a) providing a device for measuring electrode potentials, comprising at least one metal sample and at least one reference electrode at a location close to the installation within the natural body of water;
b) continuously or intermittently measuring potential differences between said at least one metal sample and said at least one reference electrode over a sufficiently long period of time to allow for identifying any changes of potential of the sample, which result from ennoblement caused by biofilm formation;
c) comparing the measured potential difference to one or more reference values for the respective metal of the metal sample; and
d) estimating if and when the potential difference resulting from biofilm formation attains or may attain a critical value which would result in the corrosion of the respective metal at the respective location of the natural body of water.
